(19) United States
(12) Patent Application Publication
(10) Pub. No.: US 2024/0420853 A1
(43) Pub. Date: Dec. 19, 2024

(54) High Performance Antenna for Ion Cyclotron Resonance Heating in Fusion Reactors

(71) Applicant: Radom Corporation, West Allis, WI (US)

(72) Inventors: Ian McKinney, Mequon, WI (US); Elizaveta Grushnikova, Milwaukee, WI (US); Jovan Jevtic, West Allis, WI (US)

(21) Appl. No.: 18/741,101

(22) Filed: Jun. 12, 2024

Related U.S. Application Data
(60) Provisional application No. 63/521,488, filed on Jun. 16, 2023.

(51) Int. Cl. G21B 1/13; G21B 1/05

(52) U.S. Cl. CPC G21B 1/13; G21B 1/057

(57) ABSTRACT

Any antenna for coupling energy into plasma contained magnetically within a fusion chamber employs a loop surrounding the chamber and having at least one dielectric segment operating to suppress undesirable fringing electrostatic fields.

### CROSS REFERENCE TO RELATED APPLICATION

This application claims the benefit of U.S. provisional application 63/521,488 filed Jun. 16, 2023 and hereby incorporated by reference

### STATEMENT REGARDING FEDERALLY SPONSORED RESEARCH OR DEVELOPMENT

—

### BACKGROUND OF THE INVENTION

The present invention relates generally to fusion systems and more particularly to an improved antenna for coupling energy into a plasma chamber used in such systems.

The impetus for advancing green technology arises from contemporary concerns regarding climate change and global warming, both of which significantly impact industry, healthcare, and everyday life. It is widely acknowledged that the energy sector, predominantly reliant on the consumption of natural resources, is a major contributor to climate change. Currently, only a minor proportion of energy is generated from nuclear power, which has proven to be hazardous. Additionally, a relatively small amount of energy is produced through green energy technologies. There is a pressing need for a safe and reliable energy source that not only achieves zero net atmospheric emissions but also mitigates existing environmental damage. One of the most promising concepts in clean energy is fusion energy. Harnessing energy from fusion is not a novel concept; initial attempts to utilize fusion power were undertaken in the mid-20th century. Notably, in the former Soviet Union, the first device to use a magnetic field to confine plasma in a toroidal chamber was called a Tokamak, which has remained the leading contender for industrial fusion reactors since its inception. This was followed by similar initiatives in the United States and other countries worldwide. The renowned ITER project in France is a promising international endeavor aimed at replicating the fusion processes of the sun to generate energy on Earth. The fundamental concept of magnetic confinement fusion reactors involves generating a strong static magnetic field to confine extremely hot plasma for thermonuclear reactions. These reactions, which occur continuously on the Sun, release a large amount of energy that sustains life on Earth. A fusion reactor essentially acts as a miniature Sun on Earth and, in one manifestation, uses deuterium and tritium (isotopes of hydrogen) as fuel. Deuterium (one proton and one neutron) and tritium (one proton and two neutrons) are not as radioactively hazardous as the fuels used in fission reactors. Additionally, the heat that could be released from 80 grams of a deuterium-tritium mixture in a fusion reactor is equivalent to that produced by burning approximately 1,000 tons of coal. One of the main challenges facing fusion reactor design is finding the means to heat the plasma to thermonuclear burning temperatures during ignition and then to continue providing heat to the plasma with high energy efficiency. The efficiency of the plasma heating system is important as it affects the so-called Q-factor, which determines whether the fusion reaction will be self-sustaining, i.e., whether the reactor will be able to produce net positive energy output. In this regard, one of the most promising heating systems is ion-cyclotron-resonance-heating (ICRH), which relies on the natural rotation of plasma ions, such as hydrogen, deuterium, and tritium in the presence of strong confining magnetic guide field. Depending on the strength of the static magnetic field and the ion species, the ion-cyclotron-resonance frequency can vary between 5 MHz and 200 MHz.

The ICRH power is typically in the range of several to tens of megawatts and is applied at the radio-frequency (RF) equal to the cyclotron frequency or one of its harmonics. The RF power is typically delivered to the reactor through high-power coaxial transmission lines which are connected to specially designed ICRH antennas facing the plasma. A particularly challenging requirement for the ICRH antenna is to deliver the radio-frequency electric field to the center of the plasma (far from the antenna and near the major radius of the tokamak) where the ion-cyclotron-resonance takes place, while avoiding energy losses in the plasma near the antenna. Any electric field hot spots near the antenna will readily produce undesirable losses in the highly conductive plasma. In particular, the electrical field components parallel to the local direction of the static magnetic field would create large plasma currents due to large mobility of ions along the magnetic field lines. In addition to the losses, accelerated ions would cause sputtering of the surface of the reactor vessel upon impact, thus releasing impurities into the plasma and negatively affecting the progress of the fusion reactions.

Unfortunately, the most widely used ICRH antenna, the strap antenna, whether it uses a single strap or multiple straps, produces an electric field near its surface which exhibits both the hot spots and the components parallel to the static magnetic field. This is one of the reasons why the conventional ICRH antennas require a Faraday shield between the surface of the antenna and the plasma. The Faraday shield is typically constructed as a closely spaced grid of water-cooled metal tubes oriented parallel to the static magnetic field. The tube ends are in electrical contact with the inner walls of the reactor thus shorting out any electrical field components parallel to the tubes. However, this prior art solution suffers from many limitations and shortcomings:
a) Electric field components parallel to the rods of the Faraday shield cause large electrical currents to flow along the rods with associated energy losses and heating issues.
b) As the grounded Faraday shield lies near the strap antenna, it adds a large capacitive loading to the antenna circuit, thus increasing the circulating currents in the antenna circuit with associated energy losses and heating issues.
c) Increasing the number and/or the diameter of Faraday shield rods in order to improve shielding effectiveness, also increases eddy currents induced in the rods by the antenna's magnetic field, thus increasing the losses and reducing the RF magnetic field penetration into the plasma.
d) The proximity of the grounded Faraday shield to the energized antenna straps increases the likelihood of arc discharges at high power and negatively affects the maximum power rating of the antenna.
e) The necessary gap between the straps and the Faraday shield and the thickness of the shield itself add up to increase the distance between the antenna and the plasma, thus decreasing the coupling between the antenna and the plasma.
f) Although Faraday shield is effective at removing undesirable field components it is less effective in producing uniform field, i.e., the electrical field hot spots behind the Faraday shield still result in the non-uniform field distribution in the plasma.
g) Non-uniform plasma losses in the vicinity of the antenna cause large and undesirable sensitivity of antenna tuning and matching to changing plasma conditions. Difficulty in maintaining the impedance match has been recognized as one of the key disadvantages of the conventional ICRH antennas.
h) While the field variation in the plane of the Faraday shield and in the direction normal to the rods can be caried to some degree by changing the number or straps and/or distribution and phasing of the current in the straps, there is no simple way to modify the variation of field intensity in the direction parallel to the rods.
i) Antenna straps are located inside the antenna box recessed in the reactor wall. To ensure the straps are electrically insulated, the interior of the antenna box must be maintained under vacuum. Therefore, a high-power RF vacuum window, a difficult to design and manufacture component prone to damage, is required between the antenna box and the coaxial transmission line supplying the RF power to the box.

### SUMMARY OF THE INVENTION

The present invention provides an antenna for fusion systems that eliminates or minimizes the limitations outlined above

This is accomplished by replacing the conducting metal straps with low-loss dielectrics such as ceramic materials with suitably large dielectric constants.

The minimum necessary relative dielectric constant can be estimated using waveguide theory: the half-wavelength within the dielectric must be shorter than the linear dimension of the antenna aperture. For example, at a typical ICRH operating frequency of 50 MHz, the half wavelength in free-space is 3 meters long, which implies that an antenna opening 1.5 meter wide would require a dielectric material of minimum relative dielectric constant equal to (3/1.5) squared or 4, assuming that the antenna opening is uniformly filled with the dielectric. This can be readily accomplished using advanced technical ceramic low-loss materials whose relative dielectric constants range from 9.8 (alumina) to 200 (calcium-titanate) and above. Additional constructional elements, such as filling the vacuum portions of the antenna opening with a ceramic material can be accomplished using low-loss ceramics with low relative dielectric constants, which can be as low as 1.8 (boron-nitride).

The present invention identifies the electrical boundary condition on the surface of the metal conductor as one of the main reasons why prior art strap antennas produce electrical hot spots and field components parallel to the static magnetic field. Namely, the tangential electric field on the surface of the conductor is practically zero which causes all of the applied RF voltage to concentrate across the small gaps between the antenna straps and the grounded antenna housing, as illustrated in FIGS. 3B and 4B. In contrast, the tangential electric field on the surface of a dielectric does not have to be zero which allows the construction of antennas with practically uniform electric field oriented in a single desired direction, as shown in FIGS. 5 and 6, for example.

In addition, the electrical RF conduction current in a conventional strap antenna is limited to a thin layer near the surface of the conductor due to the skin effect, while the dielectric polarization current inside the dielectric is distributed throughout the volume of the dielectric. It has been experimentally demonstrated that the dielectric losses in a high-quality dielectric material can be over 100 times smaller than the conduction losses in best conductors for the same total RF current and comparable dimensions.

Furthermore, from the theory of waveguides, the use of high dielectric constant materials inside the waveguide lowers the characteristic impedance of the waveguide in proportion to the square root of the relative dielectric constant. This makes for an easier impedance matching between the waveguide and the naturally low impedance of the conductive plasma and makes the antenna more tolerable to changes in plasma properties and changes in the operating frequency.

Another significant advantage of ceramic materials for ICRH antenna applications is their compatibility with high vacuum and high operating temperatures, which are characteristic of the demanding fusion plasma environment. The ceramic materials directly facing the plasma can be specially formulated to minimize the damage to the antenna and the contamination of the plasma gas due to the abrasion of the material. The protective ceramic material, located on the plasma facing surface of the antenna, will not unduly affect the electrical performance of the antenna as long as its relative dielectric constant remains comparatively low and its thickness remains small relative to the bulk of the low-loss dielectric material of the antenna.

Returning to the specific limitations enumerated in the section “Limitations of Prior Art”, we can see that:

Limitations (a) through (e) are effectively resolved by eliminating or minimizing the need for a Faraday shield when the ICRH antenna is constructed according to the present invention.

Limitation (f) is minimized by the high uniformity of the electric field at the plasma facing surface of the antenna.

Limitation (g) is minimized by the low characteristic impedance of dielectrically loaded waveguides and cavities.

Limitation (h) is overcome by combining ceramic materials of different dielectric constants and widths within a single antenna opening, as illustrated in FIG. 5, for example.

Limitation (i) is eliminated because a dielectrically loaded waveguide or cavity can provide an effective vacuum seal between the vacuum of the fusion reactor and the high-pressure gas filling the coaxial transmission lines, provided usual vacuum sealing precautions and techniques are used at the point of contact between the ceramic material and the walls of the antenna box.

These particular objects and advantages may apply to only some embodiments falling within the claims and thus do not define the scope of the invention.

### BRIEF DESCRIPTION OF THE DRAWINGS

FIGS. 1a-d show electric and magnetic fields at four characteristic time instants arranged vertically, during one period of oscillation for four different loop antennas constructed according to the prior art each associated with a different one of Figs. a-d arranged horizontally.

FIG. 2 is a fragmentary phantom view of a fusion reactor design showing key components of a tokamak fusion reactor of relevance to the present invention.

FIGS. 3a-c illustrates the construction and electric field of a prior art ICRH antenna with a single strap, showing respectively a side cross-sectional view, a front view, and a front view with electrostatic shielding in front of the antenna shown in phantom.

FIGS. 4a-c are figures similar to FIGS. 3a-c showing the construction and electric field of a prior art ICRH antenna with three straps.

FIGS. 5a-d are figure similar to FIGS. 3a-c showing the face views and electric field views (in vertical alignment) of several ICRH antenna embodiments according to the present invention, wherein the antenna is segmented in the direction of static magnetic field and further showing an electrostatic field profile in vertical alignment with respect to face views and electrical field views, the profile taken along a cross-section horizontally with respect to the face views aligned with the magnetic axis.

FIG. 6a-c are figures similar to FIGS. 5-c showing the face views and electric field views of additional embodiments of the ICRH antenna according to the present invention, wherein the antenna is segmented across its height in the direction at right angle to the static magnetic field with cuts aligned with the static magnetic field.

FIGS. 7a-c are side cross-sectional views similar to FIGS. 3a and 4a of several embodiments of the ICRH antennas according to the present invention, fed by a coaxial transmission line.

FIG. 8a is a side view of several embodiments of the ICRH antennas according to the present invention, fed by a waveguide and FIG. 8b is a side view of FIG. 6b.

FIG. 9 shows side and face views of the another embodiment of the ICRH antenna according to the present invention providing a tapered transition from the coaxial feeder line, and better conforming to the cavity curvature and the poloidal magnetic fields.

### DETAILED DESCRIPTION OF THE PREFERRED EMBODIMENT

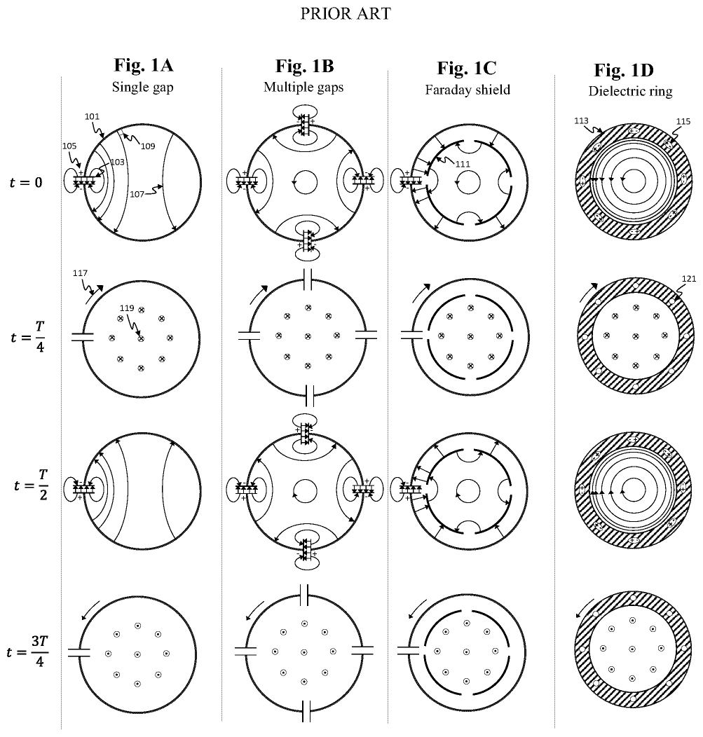

The rows in FIG. 1 correspond to four different time instants during a single period of oscillation of a resonant single-loop antenna. The instants are t=0, T/4, T/2, 3T/4, where T is the period of the oscillation. The columns in FIG. 1 correspond to four prior art ways to construct a single-loop antenna. In FIG. 1, the conductor 101 forms an inductive loop interrupted by one or more capacitors or gaps 103 to form a resonant electrical circuit. The oscillating charge 105 creates current 117 as it oscillates between the capacitor plates 103 through the conductor 101. As can be seen from rows two and four, corresponding to times t=T/4 and t=3T/4, the magnetic field 119 created by the oscillating current 117 is very nearly uniform, implying that a single loop antenna is capable of producing a near-ideal magnetic field. However, as the first and third rows illustrate, at times t=0 and t=T/2, the localized charges 105 stored on the capacitors 103 create a strong electrostatic field component which greatly overshadows the desired purely inductive electrical field which is only exhibited in its pure form by the dielectric ring resonator shown in FIG. 1D and disclosed in the U.S. Pat. No. 9,491,841 assigned to the assignee of the present application and hereby incorporated by reference. The undesired electrostatic field component is a well-recognized problem in many radiofrequency applications including antennae for ICRH. One way to combat this problem is illustrated in FIG. 1B, which consists of breaking the conductor 101 with multiple capacitors or gaps 103. One strong electric field hotspot near a single capacitor is distributed over a number of capacitors such that a multiple number of weaker hotspots are generated instead. Another way to reduce the effect of undesired electrostatic field is to interpose a Faraday shield between the single loop antenna and the region of interest as shown in FIG. 1C. The only known way to completely eliminate electrostatic fields is to use a dielectric ring resonator antenna which relies on the oscillations of the molecules 115 and 121 to replace the conduction current with the dielectric polarization current, as shown in FIG. 1D.

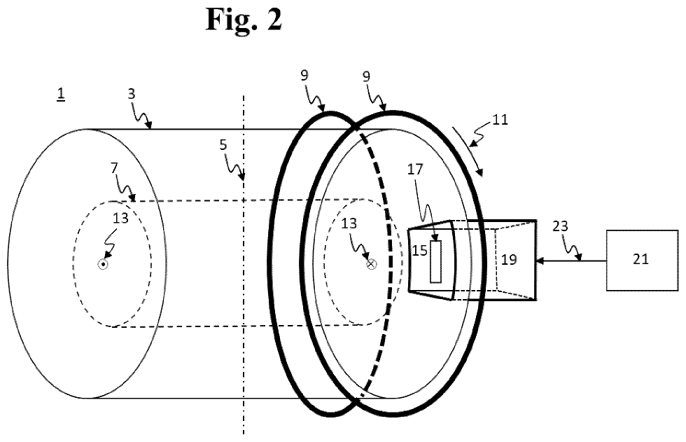

FIG. 2 shows the key components of the tokamak fusion reactor 1 of relevance to the present invention. The inner wall of vacuum vessel 3 is electrically conductive and in the form of toroid with axis 5 and contains fusion plasma 7. A multiplicity of superconducting coils 9 carries DC electrical current 11 which creates a static magnetic field 13 in the toroidal direction generally defining a magnetic field axis. The antenna opening 15 in the inner wall 3 serves as an interface between the ICRH antenna 17 located inside the antenna box 19. The radio-frequency power for the antenna 17 is provided by one or more high power radio-frequency generators 21 via one or more high-power coaxial transmission lines 23.

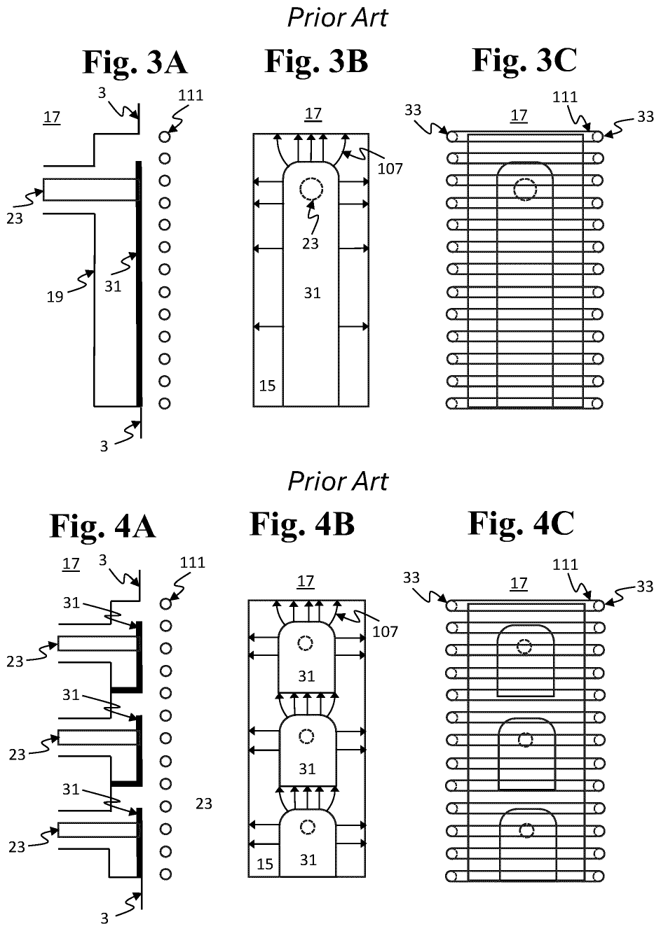

FIG. 3 shows the construction and electric field lines of a conventional single strap ICRH antenna 17 according to prior art. FIG. 3A is a side view of the antenna: straps 31 driven by the coaxial transmission line 23 on one end and is electrically connected to the inner wall 3 at the other end. In this and all subsequent depictions of transmission line 23 it will be understood that the center element labeled 23 is the center conductor of the coaxial cable and the coaxial shield of the coaxial cable comprising its return is depicted by the flanking lines above and below this labeled element 23, in this figure the coaxial shield connected variously to the inner wall 3 and antenna box 19. This construction is electrically analogous to a single gap loop antenna shown in FIG. 1A where the conductive inner wall provides the majority of the extent of the loop and the capacitance occurs at the strap 31. The electrical field lines 107, shown in face view in FIG. 3B, exhibit two undesirable properties: 1) electrical hot spots due to the concentration of electrical field near the gap between the strap 31 and wall 3 and 2) non-zero electrical field component in the direction parallel to the static magnetic field 13 (horizontal direction in FIG. 3B). A universally accepted way to deal with these limitations is to introduce a Faraday shield 111 in the form of closely spaced, electrically conducting bars placed in front of the antenna and oriented in the direction of the static magnetic field 13. The bars serve to short-circuit the undesirable field components and are connected to the conductive inner wall 3 by electrical joints 33.

FIG. 4 shows the construction and electrical fields lines of a conventional ICRH antenna 17 with three straps according to prior art. FIG. 4A is a side view of the antenna: straps 31 are driven by coaxial transmission lines 23 on one end and are electrically connected to inner wall 3 at the other end. This construction is electrically analogous to a multiple gap loop antenna shown in FIG. 1B. The electrical field lines 107, shown in face view in FIG. 4B, exhibit the same undesirable properties as in the case of a single strap ICRH antenna although to a lesser degree. A Faraday shield 111 is still commonly applied.

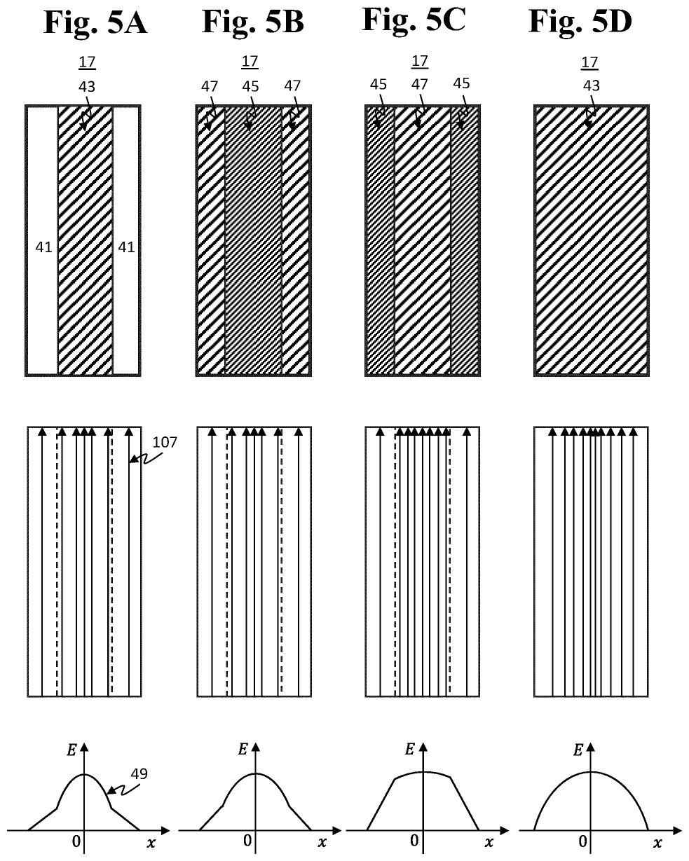

FIG. 5 is the face view of several embodiments of the ICRH antenna 17 according to the present invention. In FIG. 5A, the conventional strap 31 has been replaced by low-loss, high-dielectric-constant (relative permittivity) dielectric material, preferably an advanced technical ceramic such as alumina or calcium titanate, while the rest of antenna opening 15 remains as vacuum 41. Generally the dielectric constant will be in excess of that of vacuum or air at STP and humidity and more generally greater than 1.1 and preferably greater than 1.8. The electrical field lines 107 are nearly perfectly uniform along the direction of the antenna and have practically no components parallel to the static magnetic field 13. Therefore, this antenna removes both serious limitations that were identified in relation to the conventional ICRH strap antennae shown in FIGS. 3 and 4, i.e. both the hot spots and the undesired field components are completely removed. The variation of the field intensity 49 along the short direction of the antenna is governed by the ratio of dielectric constants of materials 43 and the vacuum 41. Depending on the design requirements, the variation 49 can be modified by using two different dielectric materials, higher-dielectric-constant material 45 and lower-dielectric-constant material 47.

In FIG. 5a and in all subsequent figures, the current flow through the higher dielectric constant material 45 is generally an oscillating dielectric polarization current directed circumferentially around the magnetic field axis (vertically as depicted) primarily returning in loops to the left and right side of the dielectric through conductive material of the antenna box 19 which, for example, may be a conductive metal material 5B illustrates construction, electrical field lines, and variation when material 45 is at the center and material 47 fills the sides of the antenna opening 15. Alternatively, FIG. 5C illustrates the construction, electrical field lines, and variation when lower dielectric constant material 47 is at the center and higher dielectric constant material 45 fills the sides of the antenna opening 15. It can be observed that a more uniform field profile in the short antenna direction results from the configuration shown in FIG. 5C. Finally, FIG. 5D shows a nearly sinusoidal field profile in the short antenna direction when a single ceramic dielectric material 43 is used throughout the antenna opening 15.

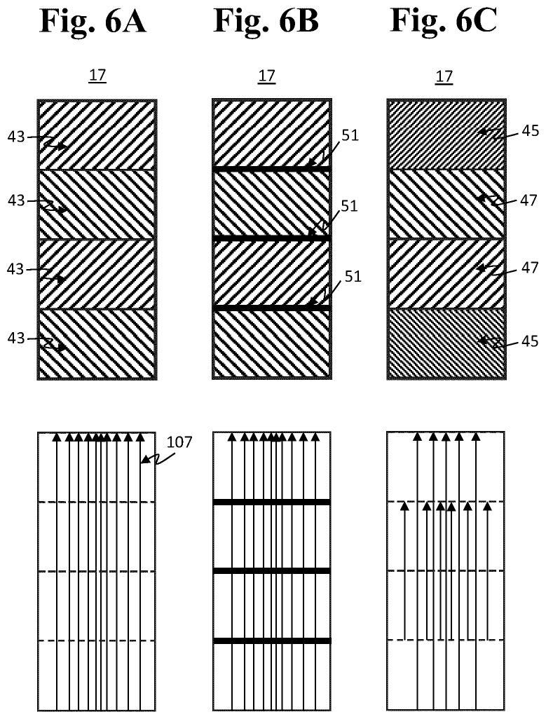

FIG. 6 shows the face view of several embodiments of the ICRH antenna 17 according to the present invention, where the dielectric is split along the planes parallel to the short side of the antenna. In FIG. 6A, dielectric 43 is shown divided in several parts mostly for constructional, installation, servicing, and manufacturing reasons and functionally operates like a single monolithic dielectric. In FIG. 6B, electrically conductive walls 51 are inserted between the ceramic pieces 43 in order to form radiofrequency waveguides and to suppress higher-order modes. Generally, the dimension of the ceramic part 43 in the direction of the electrical field should be smaller than the dimension of the ceramic part 43 in the orthogonal direction that is also in the plane of the antenna opening 15. As shown by the field lines 107, the field pattern is essentially unaffected by the splitting of the ceramic 43 or by the conductive walls 51.

Referring to FIG. 6c, the present invention also allows custom forming of the field profile in the long direction of the antenna. For example, it may be desirable to reduce the abrupt change of electric field strength or intensity along the short sides of the antenna as the field transitions from antenna opening 15 to inner wall 3, because abrupt field changes cause field diffraction that may interfere with the desired field pattern. This goal may be accomplished, according to the present invention, by dividing the dielectric as described above with respect to FIG. 6a but using different dielectrics for each of the segments, for example, using lower-dielectric-constant material 47 near the center of antenna opening 15 and higher-dielectric-constant material 45 away from the center of antenna opening 15, as shown in FIG. 6C. The resulting electrical field lines 107 show higher density inside the materials 47 and lower density inside the materials 45.

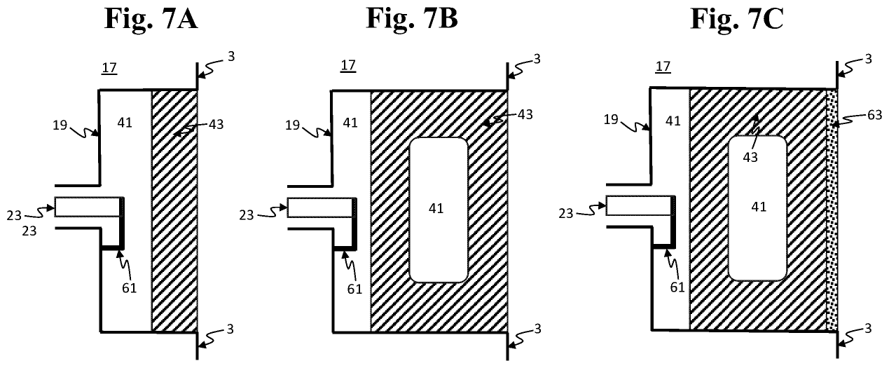

FIG. 7 illustrates the side view of several embodiments of the ICRH antenna 17 according to the present invention, when driven by a coaxial transmission line 23. In FIG. 7A, the strap of a conventional ICRH antenna is replaced by a slab of ceramic 43, which forms a resonant cavity with the electrically conductive walls of antenna box 19. The relative dielectric constant and thickness of material 43 as well as the size of the vacuum portion 41 should be selected to form a cavity resonant near the operating frequency coupled to the cavity by the coupling loop 61. FIG. 7b shows an alternative cavity consisting of a closed loop dielectric material 43, effectively forming a dielectric ring resonator. The advantage of this configuration is that most of the electrical current inside the cavity circulates in the form of a dielectric polarization current inside the low-loss ceramic material 43 which can have as much as a factor of one hundred lower losses than copper. FIG. 7c shows an additional layer of protective ceramic material 63 facing the harsh fusion plasma environment inside the inner walls 3. The properties of this material can be optimized for its refractory and non-contaminating properties in order to minimize the damage to the antenna 17 and to reduce the contamination of the fusion plasma. The dielectric properties and loss tangent of material 63 are not as critical as that of the main ceramic material 43 because the thickness of ceramic material 63 is substantially smaller than the thickness of ceramic material 43.

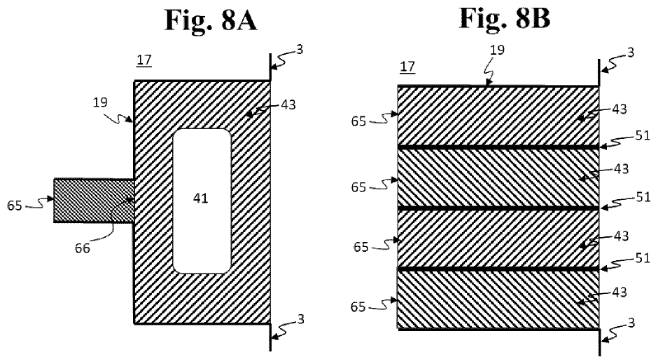

FIG. 8 illustrates the side view of several embodiments of the ICRH antenna 17 according to the present invention, when driven by a dielectrically-loaded waveguide 65. FIG. 8a shows a dielectric ring resonator 43 filling the antenna box 19 except for the central vacuum portion 41. The radiofrequency energy from dielectrically-loaded waveguide 65 is coupled to the dielectric resonator 43 through waveguide opening 66. FIG. 8b is the side view corresponding to the face view shown in FIG. 6a illustrating the feeding of ceramic segments 43 separated by conducting walls 51 using radiofrequency dielectrically-loaded waveguides 65.

FIG. 9 shows the preferred embodiment of the ICRH antenna 17 according to the present invention. The antenna shown consists of 2×4 segments 43 and is driven by eight coaxial transmission lines 23. FIG. 9A shows the side view and FIG. 9B shows the face view. The transition between coaxial transmission lines 23 and segments 43 is accomplished through tapered waveguide transition 67 and dielectrically-loaded waveguides 65. The antenna is protected from the fusion plasma environment by the protective ceramic layer 63 which may have a different or lesser dielectric constant than the dielectric resonator 43 but be better able to resist heat. As is common in the practice, the individual antenna segments 43 are rotated to align with the local direction of the static magnetic field 13, whose direction is not only affected by the superconducting coils 9 but also by the current through the fusion plasma 7, which introduces the poloidal component to the static magnetic field.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

As used herein, electrically conductive refers to a material that can sustain a direct current indefinitely upon application of a constant voltage with an electrical resistivity of less than 1 ohm meter.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties

To aid the Patent Office and any readers of any patent issued on this application in interpreting the claims appended hereto, applicants wish to note that they do not intend any of the appended claims or claim elements to invoke 35 U.S.C. 112 (f) unless the words “means for” or “step for” are explicitly used in the particular claim.

What we claim is:

1. A fusion device comprising:
a fusion chamber;
a magnet system generating a magnetic field along an axis through the fusion chamber for containing the plasma at fusion energies within the fusion chamber;
and antenna housing presenting an opening communicating with the fusion chamber, the opening providing a conductive peripheral portion;
a solid dielectric segment blocking direct current flow positioned within the opening to support an oscillating current flow through the solid dielectric segment and conductive peripheral portions.

2. The fusion device of claim 1 wherein the dielectric segment has a dielectric constant of greater than 1.1.

3. The fusion device of claim 1 wherein the opening extends along the fusion chamber in a direction about the axis over less than 25% of the distance around the fusion chamber in the direction.

4. The fusion device of claim 1 wherein the peripheral portions are a conductive metal.

5. The fusion device of claim 1 wherein dielectric is comprised of segments of different dielectric constants at location separated in a direction perpendicular to current flow through the loop and parallel to the axis.

6. The fusion device of claim 4 wherein the axially outer segments of different dielectric constants have higher dielectric constant than inner segments axially toward the center of the dielectric.

7. The fusion device of claim 1 wherein dielectric is comprised of segments of different dielectric constants at locations separated in a direction along current flow through the loop.

8. The fusion device of claim 1 wherein dielectric is comprised of segments of divided by conductive separators.

9. The fusion device of claim 1 wherein the antenna housing provides a conductive resonant cavity holding the dielectric and further including a second stub antenna for exciting the conductive resonant cavity into a cavity resonance to couple energy to the dielectric.

10. The fusion device of claim 8 wherein dielectric is a ring having an axis parallel to the magnetic axis and displaced outside of the fusion chamber.

11. The fusion device of claim 1 wherein dielectric is comprised of segments of different dielectric constants at location separated in a direction perpendicular to current flow through the loop and perpendicular to the axis including a heat shield segment exposed to the fusion chamber providing greater heat resistance than a segment further removed from the fusion chamber and covering the segment further removed from the fusion chamber.

12. A method of operating a fusion device having a fusion chamber with a magnet system generating a magnetic field along an axis through the fusion chamber for containing the plasma at fusion energies within the fusion chamber, the method comprising:
(a) positioning an antenna housing to present an opening communicating with the fusion chamber, the opening providing a conductive peripheral portion and holding a solid dielectric segment blocking direct current flow positioned within the opening;
(b) exciting the antenna to generate an oscillating current flow through the solid dielectric segment and conductive peripheral portions to couple energy to a contained plasma within the fusion chamber.

13. The method of claim 12 wherein the opening extends along the fusion chamber in a direction about the magnetic axis over less than 25% of the distance around the fusion chamber.

14. The method of claim 12 wherein the peripheral portions are a conductive metal.

15. The method of claim 12 wherein dielectric is comprised of segments of different dielectric constants at location separated in a direction perpendicular to current flow through the loop.

16. The method of claim 15 wherein the axially outer segments of different dielectric constants have higher dielectric constant than inner segments axially toward the center of the dielectric.

17. The method of claim 12 wherein dielectric is comprised of segments of different dielectric constants at locations separated in a direction along current flow through the loop.

18. The method of claim 12 wherein dielectric is comprised of segments of divided by conductive separators.

19. The method of claim 12 wherein the antenna housing provides a conductive resonant cavity holding the dielectric and further including a second stub antenna for exciting the conductive resonant cavity into a cavity resonance to couple energy to the dielectric.

20. The method of claim 19 wherein dielectric is a ring having an axis parallel to the magnetic axis and displaced outside of the fusion chamber.
